(19) United States
(12) Patent Application Publication
(10) Pub. No.: US 2021/0047019 A1
(43) Pub. Date: Feb. 18, 2021

(54) SELF-BALANCING CONTROL METHOD AND SYSTEM FOR AN UNMANNED UNDERWATER VEHICLE

(71) Applicant: SHENZHEN GENEINNO TECHNOLOGY COMPANY LTD, SHENZHEN (CN)

(72) Inventors: SHENGWEI WANG, SHENZHEN (CN); JUNPING HUANG, SHENZHEN (CN)

(21) Appl. No.: 17/088,609

(22) Filed: Nov. 4, 2020

Related U.S. Application Data
(63) Continuation of application No. PCT/CN2018/112597, filed on Oct. 30, 2018.

(30) Foreign Application Priority Data
May 9, 2018 (CN) 201810436252.7

(51) Int. Cl. B63G 8/16; G05D 1/08; B63B 79/40; B63B 39/00; B63G 8/08; B63G 8/00

(52) U.S. Cl. CPC B63G 8/16; G05D 1/0875; B63B 79/40; B63G 2008/002; B63G 8/08; B63G 8/001; B63B 39/00

(57) ABSTRACT

Disclosed is a self-balancing control method for an unmanned underwater vehicle (UUV) that includes: fitting the UUV vehicle with at least one reversible propeller; converting the forces the unmanned underwater vehicle is subjected to into a resultant force in each of at least one degree of freedom (DOF) of motion based on a DOF of motion control model, where each of the DOF of motion corresponds to a measurable motion control parameter; designing a corresponding sub-PID controller according to each of the at least one DOF of motion; and calculating the thrust required by each of the at least one reversible propeller based on a thrust distribution matrix.

### CROSS-REFERENCE TO RELATED APPLICATIONS

This application is a continuation of co-pending International Patent Application Number PCT/CN2018/112597, filed on Oct. 30, 2018, which claims the priority of Chinese Patent Application Number 201810436252.7 filed on May 9, 2018 with China National Intellectual Property Administration, the disclosures of which are incorporated herein by reference in their entireties.

### TECHNICAL FIELD

This application relates to the technical field of underwater detection robots, and more particularly relates to a self-balancing control method and system for an unmanned underwater vehicle (UUV).

### BACKGROUND

PID (proportional-integral-derivative) motion control technology and algorithm is a control method and strategy based on the concept of feedback to reduce uncertainty. It is currently the most widely used control regulator in engineering practice. PID controller (proportional-integral-derivative controller) is a common feedback loop component used in industrial control applications. It consists of a proportional unit P, an integral unit I, and a derivative unit D. The basis of PID control is proportional control. Integral control can eliminate steady-state errors, but may increase overshoot. Derivative control can increase the responsiveness of large inertia systems and weaken the trend of overshoot. For the time being, underwater robots mostly use common PID or PI controllers for purposes of motion control, and generally they are mainly aimed at closed-loop control in the direction of a single degree of freedom. Included are a depth holding PID controller serving the closed-loop control strategy that holds the unmanned underwater vehicle steadily at a specific depth, a direction holding PID controller serving the closed-loop control strategy that maintains the unmanned underwater vehicle to navigate at a specific heading, and an attitude stabilization PID controller serving the closed-loop control strategy that maintains the unmanned underwater vehicle at a stable attitude.

In current closed-loop control strategies of unmanned underwater vehicles, the depth holding PID controller, the direction holding PID controller, and the attitude stabilization PID controller are all single-function control strategies. Generally, each PID controller works independently, and 1 or 2 PID controllers may be activated depending on specific needs, so that it is difficult to fulfill comprehensive self-balancing suspension control of the main body. Furthermore, an individual thruster may only control some rather than all of the thrusters, which when combined with the control signals intended for other thrusters issued from a terminal device, may render the PID closed-loop control effect not obvious and effective.

### SUMMARY

This application provides a self-balancing control method and system for an unmanned underwater vehicle, which aims to solve one of the above technical problems in the prior art at least to a certain extent.

In order to solve the above problems, this application provides the following technical solutions.

There is provided a self-balancing control method for an unmanned underwater vehicle that includes the following operations:

operation a: arranging at least one reversible propeller on the unmanned underwater vehicle;

operation b: converting the forces the unmanned underwater vehicle is subjected to into a resultant force on at least one degree of freedom (DOF) of motion based on a degree of freedom of motion control model, where the degree of freedom of motion corresponds to a measurable motion control parameter;

operation c: designing a corresponding sub-PID controller according to each degree of freedom of motion; and

operation d: calculating the thrust required by each of the at least one reversible propeller through a thrust distribution matrix.

The technical solution adopted in the embodiments of this application may further include the following. In operation a, a number of 6 reversible propellers may be provided, including 4 reversible propellers that provide vertical thrusts completely perpendicular to the plane of the body, and 2 reversible propellers that provide horizontal thrusts completely parallel to the plane of the body.

The technical solution adopted in the embodiments of this application may further include the following. In operation b, the thrusts of the 6 propellers are converted into resultant forces on 5 degrees of freedom of motion, and the 5 degrees of freedom of motion correspond to 5 measurable motion control parameters, including heave-depth, pitch-pitch angle, roll-roll angle, translation-horizontal displacement, and bow turning-heading angle.

The technical solution adopted in the embodiments of this application may further include the following. In operation c, the sub-PID controllers may include a position holding PID, depth holding PID, direction holding PID, roll stabilization PID, and pitch stabilization PID.

The technical solution adopted in the embodiments of this application may further include the following. The sub-PID controllers may be implemented as incremental PID or common PID incorporating integral separation. That is, when the deviation between the controlled variable and the set value is relatively large, the integral action may be cancelled thus reducing the excessive feedback control caused by the large static error. When the controlled variable is close to the set value, integral control is introduced to eliminate static error thus improving the control precision.

The technical solution adopted in the embodiments of this application may further include the following. Operation d may further include: establishing an overall PID control system and providing PID controller calling logic, which may specifically include the following. The depth holding PID, the direction holding PID, the roll stabilization PID, and the pitch stabilization PID start and work together by default. The resultant forces fed back and output by the sub-PID controllers in the running state must always be combined with the forces required by the commands of a control terminal to become the resultant forces required for the rigid body movement of the unmanned underwater vehicle.

The technical solution adopted in the embodiments of this application may further include the following. Operation d may further include: imposing a saturation limit on each thrust, which cannot exceed the limit.

Another technical solution adopted by embodiments of this application is a self-balancing control system for an unmanned underwater vehicle, the self-balancing control system including a reversible propeller, a degree of freedom of motion control module, a sub-PID controller, and a thrust distribution matrix calculation module. The reversible propeller is used to provide thrust for purposes of driving the unmanned underwater vehicle. The degree of freedom of motion control module is used to convert the forces the unmanned underwater vehicle is subjected to into a resultant force on at least one degree of freedom of motion based on the degree of freedom of motion control model, where the degree of freedom of motion corresponds to a measurable motion control parameter. The sub-PID controller corresponds to each degree of freedom of motion. The thrust distribution matrix calculation module is used to calculate the thrusts required by the reversible propeller.

The technical solution adopted in the embodiments of this application may further include the following. There may be provided a number of 6 of the reversible propeller, including 4 reversible propellers that provide vertical thrusts completely perpendicular to the plane of the body, and 2 reversible propellers that provide horizontal thrusts completely parallel to the plane of the body. The thrusts of the 6 propellers may be converted into resultant forces on 5 degrees of freedom of motion, and the 5 degrees of freedom of motion correspond to 5 measurable motion control parameters, including heave-depth, pitch-pitch angle, roll-roll angle, translation-horizontal displacement, and bow turning-heading angle.

The technical solution adopted in the embodiments of this application may further include the following. The self-balancing control system for the unmanned underwater vehicle may further include a thrust saturation limit module used to impose a saturation limit on each thrust, which cannot exceed the saturation limit. The sub-PID controllers may include a depth holding PID, a direction holding PID, a roll stabilization PID, and a pitch stabilization PID. The sub-PID controllers may be implemented as incremental PID or common PID incorporating integral separation. That is, when the deviation between the controlled variable and the set value is relatively large, the integral action may be cancelled thus reducing the excessive feedback control caused by the large static error. When the controlled variable is close to the set value, integral control is introduced to eliminate static error thus improving the control precision.

Compared with the related art, embodiments of this application may provide the following beneficial effects. The self-balancing control method and system for an unmanned underwater vehicle according to the embodiments of this application implement the control of the unmanned underwater vehicle through the attitude self-balancing closed-loop motion controller dedicated to six-thruster unmanned underwater vehicles, which provides ease of programming and implementation and facilitates debugging and modification. The application of the PID controller can be implemented in the software of the water surface control terminal, and does not cause too much burden and high requirements on the hardware system of the unmanned underwater vehicle. The self-balancing control method and system for the unmanned underwater vehicle according to the embodiments of this application can fulfill the closed-loop motion control of the unmanned underwater vehicle in 5 degrees of freedom in a very smooth and quick manner. The control system has a high degree of coupling, the control algorithm is easy to implement, and the control strategy is simple and efficient.

### BRIEF DESCRIPTION OF DRAWINGS

FIG. 1 is a flowchart illustrating a self-balancing control method for an unmanned underwater vehicle according to an embodiment of the present application.

FIG. 2 is a schematic diagram illustrating the thrust distribution and 5-degree-of-freedom motion of an unmanned underwater vehicle according to an embodiment of the present application.

FIG. 3 is a block diagram illustrating a self-balancing control system for an unmanned underwater vehicle according to an embodiment of the present application.

### DETAILED DESCRIPTION

For a better understanding of the objections, technical solutions and advantages of this application, the application will be further described in further detail below in connection with the accompanying drawings and embodiments. It should be understood that the specific embodiments described here are merely used to explain the application, and not used to limit the application.

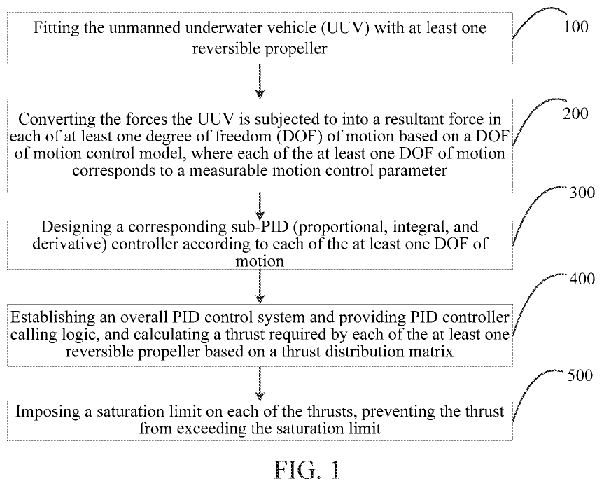

FIG. 1 is a flowchart illustrating a self-balancing control method for an unmanned underwater vehicle according to an embodiment of the present application. The self-balancing control method for an unmanned underwater vehicle according to this embodiment of the present application may include the following operations.

In operation 100, at least one reversible propeller is arranged on the unmanned underwater vehicle.

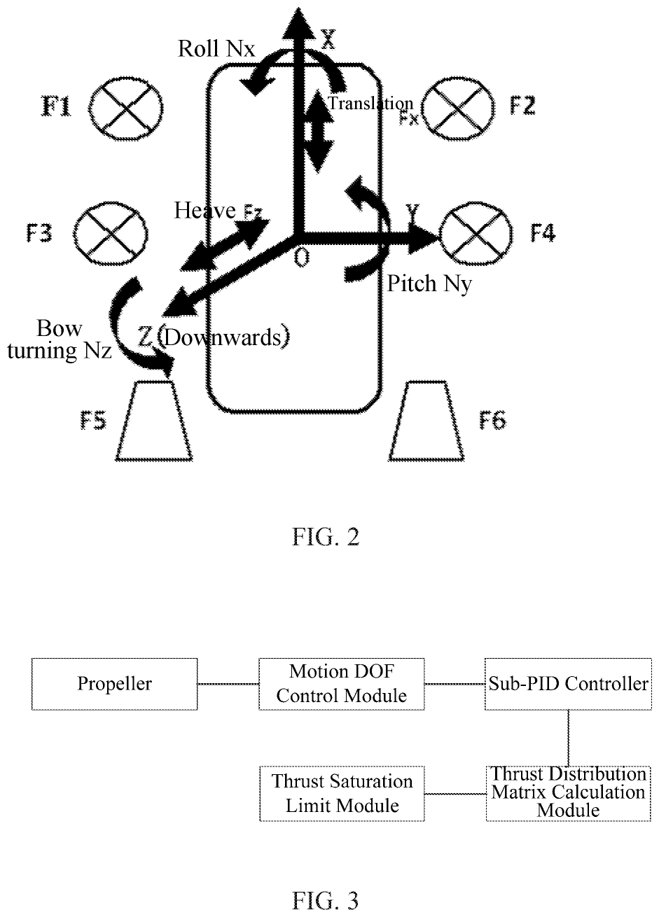

In operation 100, the self-balancing control method for the unmanned underwater vehicle according to this embodiment may fit the unmanned underwater vehicle with 6 reversible propellers, which in the mechanical model may represent 6 external forces that can act on the main body, with 4 of them being vertical thrusts that are completely perpendicular to the plane of the main body, and 2 of them being horizontal thrusts that are completely parallel to the plane of the main body. Through the mechanical model simplification process, it can be simplified to a rigid structure subjected to six external forces. With combined reference to FIG. 2, which shows the thrust distribution and 5-DOF motion of the unmanned underwater vehicle. In FIG. 2, the four vertical thrusts enable the unmanned underwater vehicle to perform motion in three degrees of freedom, including heave (along the Z axis), pitch (rotate around the Y axis), and roll (rotate around the X axis). The two horizontal thrusts enable the unmanned underwater vehicle to perform motion in two degrees of freedom, including translation (along the X axis) and bow turning (around the Z axis).

In operation 200, the forces the unmanned underwater vehicle is subjected to are converted into a resultant force on at least one degree of freedom of motion based on a degree of freedom of motion control model, where the degree of freedom of motion corresponds to a measurable motion control parameter;

In the self-balancing control method for an unmanned underwater vehicle according to this embodiment, the six thrusts exerted on the unmanned underwater vehicle are converted into a control model in the directions of 5 degrees of freedom, and the thrusts of the 6 thrusters will eventually be converted into the resultant forces in the 5 degrees of freedom. There is a conversion relationship between the control model of the unmanned underwater vehicle and the original mechanical model. The six-thrust mechanical model is converted into a 5-degree-of-freedom control model through a control matrix B.

$$B [ \begin{matrix}{F}_{1} \\ {F}_{2} \\ {F}_{3} \\ {F}_{4} \\ {F}_{5}\end{matrix} ] = [ \begin{matrix}F x \\ F z \\ N z \\ N x \\ N y\end{matrix} ]$$

Because the 5 degrees of freedom of motion correspond to 5 measurable motion control parameters, including heave-depth, pitch-pitch angle, roll-roll angle, translation-horizontal displacement, and bow turning-heading angle, where each of the motion control parameters is individually related to the respective degree of freedom of motion, such a 5-degree-of-freedom motion control model makes it very convenient for the PID controller design of subsequent models.

According to the requirements of underwater unmanned underwater vehicle (UUV) engineering and the principle of practicability, the design of PID closed-loop automatic feedback control should also follow the principle of practicality.

In operation 300, a corresponding sub-PID controller is designed according to each degree of freedom of motion.

In the self-balancing control method for an unmanned underwater vehicle according to this embodiment, the unmanned underwater vehicle can fulfill motion in 5 degrees of freedom, and a sub-PID controller is designed corresponding to each degree of freedom, thereby avoiding the need of establishing too complicated PID controllers that need to consider multiple degrees of freedom. The corresponding sub-PID controllers may include the following. A position holding PID (or referred to as top-flow PID): PIDA, where the axial acceleration a_x in the nine-axis sensor is integrated as the displacement, and the front and rear displacement variation ΔX feedback is used to control the resultant force F_x in the X-axis. The feedback parameter ΔX of this PID controller is not easy to be accurately obtained, so this PID controller may be considered if the hovering function needs to be added. Further is a depth holding PID: PIDH, where based on the depth signal of a depth sensor, the depth variation ΔH feedback is used to control the resultant force F_z in the Z-axis direction (depth). PIDH is a commonly used and indispensable controller. Further is a direction holding PID: PIDZ, where based on the heading angle measured by the magnetic compass, the heading angle variation Δα feedback is used to control the torque N_z around the Z axis. PIDZ is a commonly used PID controller. Further is a roll stabilization PID: PIDX, where based on the roll angle of the nine-axis sensor, the roll angle variation Δβ feedback is used to control the torque N_x around the X axis. Further included is a pitch stabilization PID: PIDY, where based on the pitch angle of the nine-axis sensor, the pitch angle variation Δγ feedback is used to control the torque N_y around the Y axis.

A typical PID controller may include a proportional parameter K_p, an integral parameter K_i, and a derivative parameter K_d.

Regarding the PID controller design in this embodiment of the present application, the feedback signals are typically displacements such as depth, heading angle, bearing angle, and the resultant forces in the controlled 5 degrees of freedom have a linear relationship with the linear acceleration, angular acceleration, etc., so the proportional parameter K_p and the integral parameter K_i play a key role. Accordingly, structural design of the PID controller should be mainly based on PI (proportional, integral), while the derivative parameter K_d plays a limited role.

The controllers may be implemented as incremental PID or common PID incorporating integral separation (that is, when the deviation between the controlled variable and the set value is relatively large, the integral action may be cancelled thus reducing the excessive feedback control caused by the large static error. When the controlled variable is close to the set value, integral control is introduced to eliminate static error thus improving the control precision.) for purposes of controlling the PID.

In operation 400, an overall PID control system is established, a PID controller calling logic is provided, and the thrust required by each of the at least one thruster is calculated based on a thrust distribution matrix.

In the establishing the overall PID control system and providing the PID controller calling logic according to this embodiment of the present application, the four PID controllers namely the depth holding PID, the direction holding PID, the roll stabilization PID, and the pitch stabilization PID are first considered, while the consideration of the position holding PIDA is temporarily suspended due to the instability of the feedback parameters. Under the “self-balancing” mode of the unmanned underwater vehicle, the above 4 PID controllers start and operate together by default. The resultant forces F_z1, N_z1, N_x1, N_y1 fed back and output by the PID controllers in the running state must always be combined with the forces F_x, F_z2, N_z2, N_x2, N_y2 required by the commands of the control terminal to become the final resultant forces F_x, F_z=F_z1 F_z2, N_z=N_z1 N_z2, N_x=N_x1 N_x2, N_y=N_y1 N_y2 required by the rigid body motion of the unmanned underwater vehicle. The thrusts of the six thrusters are each solved for from the combined forces based on the thrust distribution matrix C. Because the results calculated by the thrust distribution matrix includes the thrust required by each of the six thrusters, the self-balancing control system for an unmanned underwater vehicle in this embodiment of the present application is coupled and continuous.

In operation 500, a saturation limit is imposed on each thrust, which cannot exceed the limit.

FIG. 3 is a block diagram illustrating a self-balancing control system for an unmanned underwater vehicle according to an embodiment of the present application. The self-balancing control system for an unmanned underwater vehicle according to this embodiment of the application may include at least one reversible propeller, a degree of freedom of motion control module, at least one sub-PID controller, a thrust distribution matrix calculation module, and a thrust saturation limit module. In the self-balancing control system for an unmanned underwater vehicle according to this embodiment of the application, 6 reversible propellers may be fitted, which in the mechanical model may represent 6 external forces that can act on the main body, with 4 of them being vertical thrusts that are completely perpendicular to the plane of the main body, and 2 of them being horizontal thrusts that are completely parallel to the plane of the main body. Through the mechanical model simplification process, it can be simplified to a rigid structure subjected to six external forces. With combined reference to FIG. 2, which shows the thrust distribution and 5-DOF motion of the unmanned underwater vehicle. In FIG. 2, the four vertical thrusts enable the unmanned underwater vehicle to perform motion in three degrees of freedom, including heave (along the Z axis), pitch (rotate around the Y axis), and roll (rotate around the X axis). The two horizontal thrusts enable the unmanned underwater vehicle to perform motion in two degrees of freedom, including translation (along the X axis) and bow turning (around the Z axis). Degree of freedom of motion control module may convert the forces the unmanned underwater vehicle is subjected to into a resultant force on at least one degree of freedom of motion, where the degree of freedom of motion corresponds to a measurable motion control parameter. In the self-balancing control system for an unmanned underwater vehicle according to this embodiment, the six thrusts exerted on the unmanned underwater vehicle are converted into a control model in the directions of 5 degrees of freedom, and the thrusts of the 6 thrusters will eventually be converted into the resultant forces in the 5 degrees of freedom. There is a conversion relationship between the control model of the unmanned underwater vehicle and the original mechanical model. The six-thrust mechanical model is converted into a 5-degree-of-freedom control model through a control matrix B.

$$B [ \begin{matrix}{F}_{1} \\ {F}_{2} \\ {F}_{3} \\ {F}_{4} \\ {F}_{5}\end{matrix} ] = [ \begin{matrix}F x \\ F z \\ N z \\ N x \\ N y\end{matrix} ]$$

Because the 5 degrees of freedom of motion correspond to 5 measurable motion control parameters, including heave-depth, pitch-pitch angle, roll-roll angle, translation-horizontal displacement, and bow turning-heading angle, where each of the motion control parameters is individually related to the respective degree of freedom of motion, such a 5-degree-of-freedom motion control model makes it very convenient for the PID controller design of subsequent models. According to the requirements of underwater unmanned underwater vehicle (UUV) engineering and the principle of practicability, the design of PID closed-loop automatic feedback control should also follow the principle of practicality. The sub-PID controllers are used to fulfill the degree of freedom motion in each direction. The corresponding sub-PID controllers may include the following. A position holding PID (or referred to as top-flow PID): PIDA, where the axial acceleration a_x in the nine-axis sensor is integrated as the displacement, and the front and rear displacement variation ΔX feedback is used to control the resultant force F_x in the X-axis. The feedback parameter ΔX of this PID controller is not easy to be accurately obtained, so this PID controller may be considered if the hovering function needs to be added. Further is a depth holding PID: PIDH, where based on the depth signal of a depth sensor, the depth variation ΔH feedback is used to control the resultant force F_z in the Z-axis direction (depth). PIDH is a commonly used and indispensable controller. Further is a direction holding PID: PIDZ, where based on the heading angle measured by the magnetic compass, the heading angle variation Δα feedback is used to control the torque N_z around the Z axis. PIDZ is a commonly used PID controller. Further is a roll stabilization PID: PIDX, where based on the roll angle of the nine-axis sensor, the roll angle variation Δβ feedback is used to control the torque N_x around the X axis. Further included is a pitch stabilization PID: PIDY, where based on the pitch angle of the nine-axis sensor, the pitch angle variation Δγ feedback is used to control the torque N_y around the Y axis. A typical PID controller may include a proportional parameter K_p, an integral parameter K_i, and a derivative parameter K_d. Regarding the PID controller design in this embodiment of the present application, the feedback signals are typically displacements such as depth, heading angle, bearing angle, and the resultant forces in the controlled 5 degrees of freedom have a linear relationship with the linear acceleration, angular acceleration, etc., so the proportional parameter K_p and the integral parameter K_i play a key role. Accordingly, structural design of the PID controller should be mainly based on PI, while the derivative parameter K_d plays a limited role. The controllers may be implemented as incremental PID or common PID incorporating integral separation (That is, when the deviation between the controlled variable and the set value is relatively large, the integral action may be cancelled thus reducing the excessive feedback control caused by the large static error. When the controlled variable is close to the set value, integral control is introduced to eliminate static error thus improving the control precision.) for purposes of controlling the PID. The thrust distribution matrix calculation module is used to establish an overall PID control system and provide a PID controller calling logic, and calculate the thrust required by each of the at least one thruster. The PID control system according to this embodiment of the present application, first consider the four PID controllers namely the depth holding PID, the direction holding PID, the roll stabilization PID, and the pitch stabilization PID, while temporarily suspending the consideration of the position holding PIDA due to the instability of the feedback parameters. Under the “self-balancing” mode of the unmanned underwater vehicle, the above 4 PID controllers start and operate together by default. The resultant forces F_z1, N_z1, N_x1, N_y1 fed back and output by the PID controllers in the running state must always be combined with the forces F_x, F_z2, N_z2, N_x2, N_y2 required by the commands of the control terminal to become the final resultant forces F_x, F_z=F_z1 F_z2, N_z=N_z1 N_z2, N_x=N_x1 N_x2, N_y=N_y1 N_y2 required by the rigid body motion of the unmanned underwater vehicle. The thrusts of the six thrusters are each solved for from the combined forces based on the thrust distribution matrix C. Because the results calculated by the thrust distribution matrix includes the thrust required by each of the six thrusters, the self-balancing control system for an unmanned underwater vehicle in this embodiment of the present application is coupled and continuous. The thrust saturation limit module is configured to impose a saturation limit on each thrust, which cannot exceed the limit.

The self-balancing control method and system for an unmanned underwater vehicle according to the embodiments of this application implement the control of the unmanned underwater vehicle through the attitude self-balancing closed-loop motion controller dedicated to six-thruster unmanned underwater vehicles, which provides ease of programming and implementation and facilitates debugging and modification. The application of the PID controller can be implemented in the software of the water surface control terminal, and does not cause too much burden and high requirements on the hardware system of the unmanned underwater vehicle. The self-balancing control method and system for the unmanned underwater vehicle according to the embodiments of this application can fulfill the closed-loop motion control of the unmanned underwater vehicle in 5 degrees of freedom in a very smooth and quick manner. The control system has a high degree of coupling, the control algorithm is easy to implement, and the control strategy is simple and efficient.

The foregoing description of the disclosed embodiments will enable those having ordinary skill in the art to implement or use this application. Various modifications to these embodiments will be obvious to those having ordinary skill in the art, and the general principles defined in this document can be implemented in other embodiments without departing from the spirit or scope of the present application. Therefore, this application will not be limited to the embodiments illustrated in this document, but should assume the widest scope consistent with the principles and novel features disclosed in this document.

What is claimed is:

1. A self-balancing control method for an unmanned underwater vehicle (UUV), the self-balancing control method comprising:
fitting the UUV with at least one reversible propeller;
converting forces the UUV is subjected to into a resultant force in each of at least one degree of freedom (DOF) of motion based on a DOF of motion control model, where each of the at least one DOF of motion corresponds to a measurable motion control parameter;
designing a corresponding sub-PID (proportional, integral, and derivative) controller according to each of the at least one DOF of motion; and
calculating a thrust required by each of the at least one reversible propeller based on a thrust distribution matrix.

2. The self-balancing control method as recited in claim 1, wherein in “fitting the UUV with at least one reversible propeller”, a number of six reversible propellers are fitted, comprising four reversible propellers configured to provide vertical thrusts completely perpendicular to a plane of a main body of the unmanned underwater vehicle, and two reversible propellers configured to provide horizontal thrusts completely parallel to the plane of the main body of the unmanned underwater vehicle.

3. The self-balancing control method as recited in claim 2, wherein in “converting forces the UUV is subjected to into a resultant force in each of at least one DOF of motion based on a DOF of motion control model”, the thrusts of the 6 propellers are converted into resultant forces in 5 degrees of freedom of motion, the 5 degrees of freedom of motion corresponding to 5 measurable motion control parameters, comprising heave-depth, pitch-pitch angle, roll-roll angle, translation-horizontal displacement, and bow turning-heading angle.

4. The self-balancing control method as recited in claim 3, wherein in “designing a corresponding sub-PID controller according to each of the at least one DOF of motion”, the sub-PID controllers comprise a position holding PID, a depth holding PID, a direction holding PID, a roll stabilization PID, and a pitch stabilization PID.

5. The self-balancing control method as recited in claim 4, wherein the sub-PID controllers are implemented as incremental PID or common PID incorporating integral separation, that is, when a deviation between a controlled variable and a set value is relatively large, an integral action is cancelled thus reducing excessive feedback control caused by a large static error; when the controlled variable is close to the set value, integral control is introduced to eliminate static error thus improving control precision.

6. The self-balancing control method as recited in claim 4, wherein “calculating a thrust required by each of the at least one reversible propeller based on a thrust distribution matrix” further comprises: establishing an overall PID control system and providing PID controller calling logic, which specifically comprises: the depth holding PID, the direction holding PID, the roll stabilization PID, and the pitch stabilization PID start and work together by default; the resultant forces fed back and output by the sub-PID controllers in a running state are always combined with forces required by commands of a control terminal to become the resultant forces required for rigid body motion of the unmanned underwater vehicle.

7. The self-balancing control method as recited in claim 4, wherein “calculating a thrust required by each of the at least one reversible propeller based on a thrust distribution matrix”further comprises: imposing a saturation limit on each of the thrusts, preventing the thrust from exceeding the saturation limit.

8. The self-balancing control method as recited in claim 5, wherein “calculating a thrust required by each of the at least one reversible propeller based on a thrust distribution matrix” further comprises: establishing an overall PID control system and providing PID controller calling logic, which specifically comprises: the depth holding PID, the direction holding PID, the roll stabilization PID, and the pitch stabilization PID start and work together by default; the resultant forces fed back and output by the sub-PID controllers in a running state are always combined with forces required by commands of a control terminal to become the resultant forces required for rigid body motion of the unmanned underwater vehicle.

9. The self-balancing control method as recited in claim 5, wherein “calculating a thrust required by each of the at least one reversible propeller based on a thrust distribution matrix”further comprises: imposing a saturation limit on each of the thrusts, preventing the thrust from exceeding the saturation limit.

10. A self-balancing control system for an unmanned underwater vehicle (UUV), the self-balancing control system comprising at least one reversible propeller, a degree of freedom (DOF) of motion control module, a sub-PID (proportional, integral, and derivative) controller, and a thrust distribution matrix calculation module, wherein the at least one reversible propeller is configured to provide a thrust for purposes of driving the UUV; the DOF of motion control module is configured to convert forces the UUV is subjected to into a resultant force in at least one DOF of motion based on the DOF of motion control model, where each of the at least one DOF of motion corresponds to a measurable motion control parameter; the sub-PID controller corresponds to a respective DOF of motion; the thrust distribution matrix calculation module is configured to calculate thrusts required by the at least one reversible propeller.

11. The self-balancing control system as recited in claim 10, wherein there are fitted a number of six of the reversible propeller, comprising four reversible propellers configured to provide vertical thrusts completely perpendicular to a plane of a main body of the UUV, and two reversible propellers configured to provide horizontal thrusts completely parallel to the plane of the main body of the UUV; the DOF of motion control module is configured to convert the thrusts of the 6 propellers into resultant forces in 5 DOF of motion, the 5 DOF of motion corresponding to 5 measurable motion control parameters, comprising heave-depth, pitch-pitch angle, roll-roll angle, translation-horizontal displacement, and bow turning-heading angle.

12. The self-balancing control system as recited in claim 11, further comprising a thrust saturation limit module configured to impose a saturation limit on each of the thrusts, to prevent the thrust from exceeding the saturation limit; the sub-PID controllers comprise a depth holding PID, a direction holding PID, a roll stabilization PID, and a pitch stabilization PID; the sub-PID controllers are implemented as incremental PID or common PID incorporating integral separation, that is, when a deviation between a controlled variable and a set value is relatively large, an integral action is cancelled thus reducing excessive feedback control caused by a large static error; when the controlled variable is close to the set value, integral control is introduced to eliminate static error thus improving control precision.
